(19) United States
(12) Patent Application Publication
(10) Pub. No.: US 2020/0114649 A1
(43) Pub. Date: Apr. 16, 2020

(54) Method and device for regenerating a print head

(71) Applicant: Océ Holding B.V., Venlo (NL)

(72) Inventor: Florian Hitzlsperger, Muenchen (DE)

(73) Assignee: Océ Holding B.V., Venlo (NL)

(21) Appl. No.: 16/599,727

(22) Filed: Oct. 11, 2019

(30) Foreign Application Priority Data
Oct. 12, 2018 (DE) 10 2018 125 245.5

(51) Int. Cl. B41J 2/165

(52) U.S. Cl. CPC B41J 2/16588; B41J 2/16505; B41J 2/16535

(57) ABSTRACT

A regeneration device having a planiform separating element that, to shield between the nozzle plate of a print head and a recording medium, may be moved so that the regeneration of the print head may be implemented directly above the recording medium.

### CROSS REFERENCE TO RELATED APPLICATIONS

This patent application claims priority to German Patent Application No. 102018125245.5, filed Oct. 12, 2018, which is incorporated herein by reference in its entirety.

### BACKGROUND

### Field

The disclosure relates to a method and a device for regenerating a print head of an inkjet printing device.

### Related Art

An inkjet printing device for printing to a recording medium comprises one or more print heads respectively having one or more nozzles. The nozzles are respectively configured to eject ink droplets in order to print dots of a print image onto the recording medium. The printing process of an inkjet printing device may be interrupted in order to clean the one or more print heads. To clean the print heads, the one or more print heads may be driven from a printing position into a cleaning position that is situated laterally next to the recording medium.

The movement of a print head into a cleaning position typically takes a relatively long amount of time, and thus reduces the productivity of a printing device. Furthermore, the provision of a dedicated cleaning unit at the cleaning position of a printing device leads to an increased installation space and to additional costs.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1a is a block diagram of an inkjet printing device according to an exemplary embodiment of the present disclosure.

FIG. 1b is a cleaner of an inkjet printing device according to an exemplary embodiment of the present disclosure.

FIG. 2a is a regenerator, according to an exemplary embodiment, for regenerating at least one print head, in a view along the transport direction;

FIG. 2b shows the regenerator in a view transversal to the transport direction.

FIG. 2c shows the regenerator in a view from below of the nozzle plates of print heads of an inkjet printing device.

FIG. 3 is a cross sectional view of a guide rail according to an exemplary embodiment of the present disclosure.

FIGS. 4a and 4b illustrate the separator in operation as a cover, according to an exemplary embodiment, for the nozzle plates of print heads of an inkjet printing device.

FIG. 5 illustrates a flowchart of a method for regenerating a print head according to an exemplary embodiment of the present disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the present disclose is to enable a cost-, time-, and space-efficient regeneration of the one or more print heads of an inkjet printing device.

In an exemplary embodiment of the disclosure, a regenerator configured to regenerate at least one print head of an inkjet printing device is described. The printing device has a recording region, arranged below the print head, for a recording medium that is to be printed to by the print head. The device comprises a (flexible) planiform separating element as well as an actuator that is configured to move the separating element into an intervening space or gap between the print head and the recording region for a regeneration process, such that fluid, in particular ink and/or contaminants, that drips from the print head are captured by the separating element; and is configured to move the separating element out of the intervening space between the print head and the recording region for a printing process. Moreover, the device comprises a controller that is configured to initiate a regeneration measure to regenerate the print head when the separating element is located at least partially in the intervening space between the print head and the recording region.

In an exemplary embodiment of the disclosure, a method is described for regenerating at least one print head of an inkjet printing device. The printing device has a recording region, arranged below the print head, for a recording medium to be printed to by the print head. In an exemplary embodiment, the method includes the movement of a (flexible) planiform separating element for a regeneration process into an intervening space or gap between the print head and the recording region for a regeneration process, such that fluid (in particular ink, which possibly has contaminants such as paper dust, for example) that drips from the print head are captured by the separating element. Moreover, the method includes the implementation of at least one regeneration measure to regenerate the print head when the separating element is located at least partially in the intervening space between the print head and the recording region.

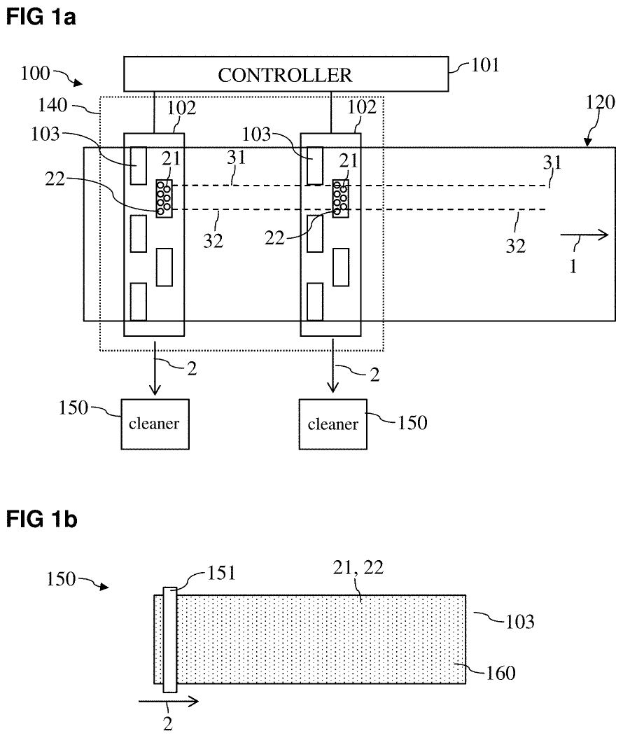

In an exemplary embodiment of the disclosure, the printing device 100 that is depicted in FIG. 1a is configured for printing to a recording medium 120 in the form of a sheet or page or plate or band. The recording medium 120 may have been produced from paper, paperboard, cardboard, metal, plastic, textiles, a combination thereof, and/or other materials that are suitable and can be printed to. The recording medium 120 is directed along the transport direction 1 (represented by an arrow) through the print group 140 of the printing device 100.

With continued reference to FIG. 1a, in an exemplary embodiment, the print group 140 of the printing device 100 includes two print bars 102, where each print bar 102 may be used for printing with ink of a defined color (for example black, cyan, magenta, and/or yellow, and Magnetic Ink Character Recognition (MICR) ink if applicable). Different print bars 102 may be used for printing with respective different inks. Furthermore, the printing device 100 typically includes at least one fixing or drying unit (not shown) that is configured to fix a print image printed onto the recording medium 120.

A print bar 102 may include one or more print heads 103 that are, if applicable, arranged side by side in multiple rows in order to print the dots of different columns 31, 32 of a print image onto the recording medium 120. In the example depicted in FIG. 1a, a print bar 102 includes five print heads 103, where each print head 103 prints the dots of a group of columns 31, 32 of a print image onto the recording medium 120.

In the embodiment depicted in FIG. 1a, each print head 103 of the print group 140 includes a plurality of nozzles 21, 22, where each nozzle 21, 22 is configured to fire or eject ink droplets onto the recording medium 120. A print head 103 of the print group 140 may, for example, include multiple thousands of effectively utilized nozzles 21, 22 that are arranged along multiple rows, transversal to the transport direction 1 of the recording medium 120. By means of the nozzles 21, 22 of a print head 103 of the print group 140, dots of a line of a print image may be printed onto the recording medium 120 transversal to the transport direction 1, meaning along the width of the recording medium 120.

In an exemplary embodiment, the printing device 100 also includes a controller 101 (e.g. an activation hardware and/or processor) that is configured to activate the actuators of the individual nozzles 21, 22 of the individual print heads 103 of the print group 140 in order to apply a print image onto the recording medium 120 depending on print data. In an exemplary embodiment, the controller 101 includes processor circuitry that is configured to perform one or more operations and/or functions of the controller 101, including activating the actuators based on print data, and/or controlling to operation of the printer 100 (including controlling one or more components of the printer 100).

The print group 140 of the printing device 100 thus includes at least one print bar 102 with K nozzles 21, 22 that may be activated with a defined line clock cycle in order to print a line, which line travels transversal to the transport direction 1 of the recording medium 120, with K pixels or K columns 31, 32 of a print image onto the recording medium 120, for example with K>1000. In the depicted example, the nozzles 21, 22 are immobile or permanently installed in the printing device 100, and the recording medium 120 is directed past the stationary nozzles 21, 22 with a defined transport velocity.

In an exemplary embodiment, the printing device 100 includes one or more cleaners 150. A print bar 102 may be transferred from a printing position, at which the print bar 102 is arranged above the recording medium 120, into a cleaning position at a cleaner 150. For this purpose, the print bar 102 may be moved in the movement direction indicated by the arrow traveling orthogonal to the transport direction 1. The printing device 100 may have a cleaner 150 for each print bar 102.

FIG. 1b shows the underside or the nozzle plate 160 of a print head 103 of a print bar 102 at a cleaner 150. The outputs of the one or more nozzles 21, 22 of the print head 103 are arranged at the underside or the nozzle plate 160 of the print head 103. In the cleaning position, the one or more nozzles 21, 22 of the print head 103 may be induced to eject ink, for example by increasing the (resting) pressure within the one or more nozzles 21, 22. This step may be referred to as “purging”. The nozzles 21, 22 are thereby flushed from the inside out with ink and are thereby cleaned. The ejected ink is typically captured by a pan. The cleaner 150 may also be configured to spray the nozzle plate 160 of a print head 103 with a cleaning fluid. The underside 160 of the print head 103 may subsequently be cleaned with a wiper 151. The wiper 151 may be moved across the nozzle plate 160 (along the one or more print heads 103 or along the print bar 102), in the cleaning direction 2 indicated by the arrow, in order to clean the nozzle plate 160 (in particular in order to wipe residual ink and/or contaminants off of the nozzle plate 160). This step may be referred to as “wiping”. The cleaning direction 2 typically travels orthogonal to the transport direction 1.

The transfer of a print head 103 or of a print bar 102 into the cleaning position is linked to a relatively high time cost. Furthermore, a cleaner 150 typically takes up a relatively large amount of installation space, and is linked with additional costs.

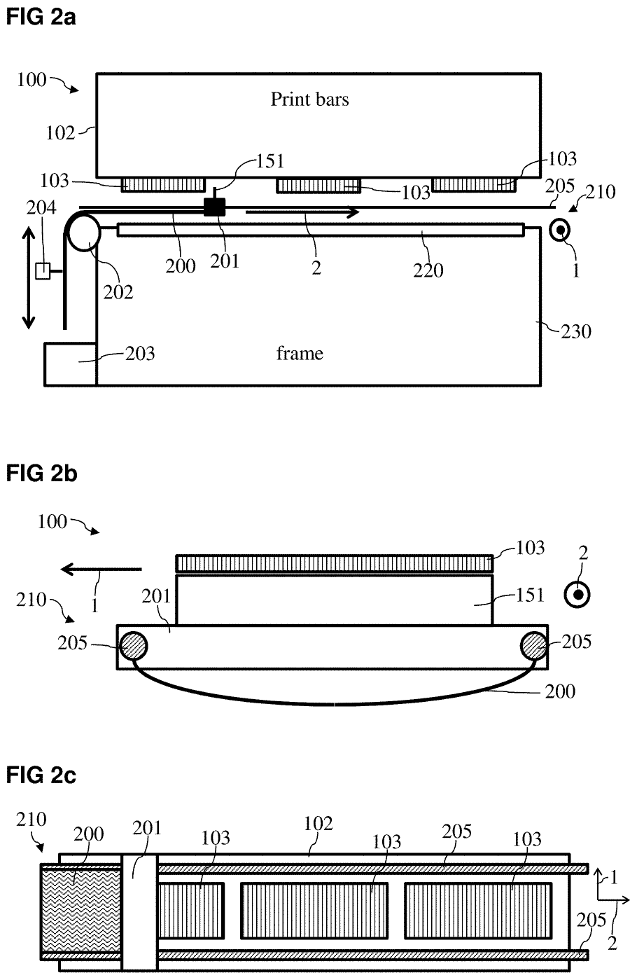

In an exemplary embodiment, the printing device 100 includes a planiform separating element 200 (see FIGS. 2a through 2c), for example for the one or more print heads 103 of a print bar 102, that may be moved between the one or more print heads 103 of a print bar 102 and the (typically underlying) recording medium 120. The region of a printing device 100 below a print bar 102 in which the recording medium 120 is typically located is referred to in this document as the recording region 220. The separating element 200 may thus be moved between the print bar 102 and the underlying recording region 220 in order to shield the recording region 220 from the print bar 102.

In an exemplary embodiment, the separating element 200 is flexible and/or deformable. In particular, the separating element 200 is preferably designed such that the separating element 200 may be significantly deformed by the action of gravity (for example in order to form a trough or a channel below the print bar 102). In an exemplary embodiment, the separating element 200 designed/configured as a film, a tarpaulin, tarp, or other water-resistant and/or water-proof layer that may be pulled between the print bar 102 and the recording region 220 for a cleaning and/or regeneration process.

FIG. 2a shows regenerator 210 configured to regenerate the one or more print heads 103 of a print bar 102 in a view along the transport direction 1. In particular, the regenerator 210 may thereby be configured to capture ink and/or contaminants. In an exemplary embodiment, the regenerator 210 includes a sled 201 that may be directed on one or more guide rails 205 along the cleaning direction 2, meaning typically transversal to the transport direction 1, past the one or more print heads 103 of the print bar 102. For example, the sled 201 may have a motor to drive a gearwheel that engages in a guide rail 205 in order to move the sled 201 along said guide rail 205.

In an exemplary embodiment, the sled 201 is configured to pull the planiform separating element 200 between the print bar 102 and the recording region 220 or the recording medium 120 given the movement along the cleaning direction 2. The separating element 200 may thereby be directed around a deflection roller 202 so that the separating element 200 travels laterally next to the frame 230 of the printing device 100, parallel to said frame 230. A spatially more compact installation of the separating element 200 may thus be enabled. In particular, during a printing process, the separating element 200 may be arranged laterally next to the frame in a side region (and may thereby be cleaned, if applicable). Furthermore, for a regeneration process the separating element 200 may be drawn laterally, next to the frame 230, into the gap or intervening space between the print bar 102 and the recording region 220 (in order to shield the recording region 220 from the print bar 102). In advance of a regeneration process, the print bar 102 typically must be raised and/or the recording region 220 must be lowered in order to increase the width of the gap or intervening space (since the nip (print gap) typically amounts to only approximately 1 mm).

In an exemplary embodiment, the separating element 200 is configured to capture contaminants (for example ink and/or cleaning fluid) falling from the nozzle plate 160 of a print head 103 such that the contaminants do not arrive in the recording region 220. A cleaning process of a nozzle plate 160 may consequently take place directly at the printing position above the recording region 220. The ink escaping upon purging of a print head 103 is thereby captured by the separating element 200. Furthermore, the ink and/or cleaning fluid that falls down upon wiping are captured by the separating element 200.

FIG. 2b shows the regenerator 210 in a view transversal to the transport direction 1 and/or along the cleaning direction 2. In an exemplary embodiment, as depicted in FIG. 2b, the regenerator 210 includes two guide rails 205, of which one is arranged before the one or more print heads 103 of the print bar 102 with regard to the transport direction 1, and one is arranged after. Furthermore, FIG. 2b shows the sled 201 that is directed along the guide rails 205. Moreover, in FIG. 2b, the separating element 200 sagging between the two guide rails 205 is shown, which separating element 200 forms a trough or a channel in which the fluid (in particular ink, including possibly present contaminants) dripping from the one or more print heads 103 are captured.

FIG. 2c shows the regenerator 210 in a view, from below, of the nozzle plates 160 of the print heads 103 of a print bar 102. The separating element 200 has thereby been drawn by the sled 201 partially across the print head 103 arranged to the left.

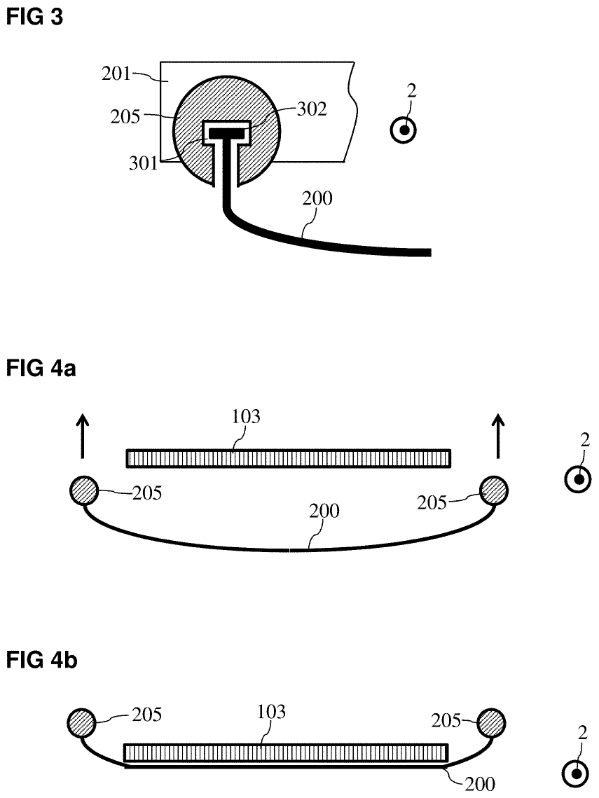

In an exemplary embodiment, the edges or borders of the separating element 200 that travel along the cleaning direction 2 may respectively be attached to a guide rail 205 in order to enable a reliable positioning of the separating element 200 between print bar 102 and recording region 220. For this purpose, a guide rail 205 (for example as depicted in FIG. 3) may have a guide groove 301 in which an edge of the separating element 200 may be borne via one or more sliding elements 302 (similar to a curtain) in order to hold the separating element 200 below a print bar 102.

As depicted in FIG. 2a, in an exemplary embodiment, the sled 201 may be used as a support for a wiper 151. In particular, the sled 201 may be configured to draw the wiper 151 across the nozzle plates 160 of the one or more print heads 103 of a print bar 102 in a common translation movement along the cleaning direction 2, and to simultaneously draw the separating element 200 between the print bar 102 and the recording region 220. A particularly efficient cleaning of the one or more print heads 103 of a print bar 102 may thus be enabled.

In an exemplary embodiment, the regenerator 210 includes a cleaner 204 (see FIG. 2a) that is configured to clean the planiform separating element 200. In an exemplary embodiment, the cleaner 204 is configured to clean the surface of the separating element 200 facing toward the print bar 102. The cleaner 204 may include one or more spray nozzles in order to spray a cleaning fluid onto the separating element 200. Furthermore, the cleaner 204 may, for example, include a wiper that is configured to wipe off the separating element 200 so that the ink, cleaning fluid, and/or contaminants captured by the separating element 200 are at least partially removed from the separating element 200.

In an exemplary embodiment, as depicted in FIG. 2a, the cleaner 204 is arranged in the side region next to the frame 230 of the printing device 100, in which side region the separating element 200 travels orthogonal to the floor, at least in part. In an exemplary embodiment, the cleaner 204 is configured to wipe off the separating element 200 while the separating element 200 is drawn between print bar 102 and recording region 220 and/or while the separating element 200 is driven out of the gap between print bar 102 and recording region 220. The contaminants that have been cleaned off of the cleaner 204 may be collected in a capture container 203.

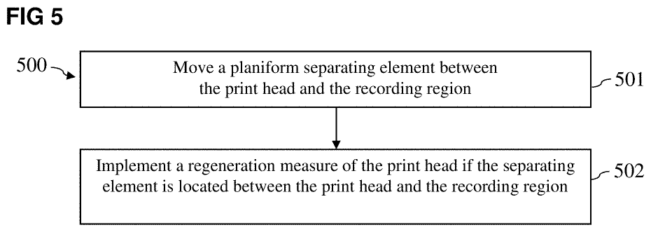

In an exemplary embodiment, the separating element 200 is configured to be used as a cover for the nozzle plates 160 of the one or more print heads 103 of a print bar 102. For this purpose, the separating element 200 arranged between the print bar 102 and the recording region 220 may be moved toward the nozzle plates 160 of the one or more print heads 103 of the print bar 102 (see the arrows in FIG. 4a), and/or the print bar 102 may be moved toward the separating element 200. In particular, the separating element 200 may be raised and/or the print bar 102 may be lowered. For example, the print bar 102 may be moved underneath the separating element 200. This may thus have the effect that the separating element 200 in a park position (above the recording region 220) covers the nozzle plates 160 of the one or more print heads 103 of the print bar 102 (see FIG. 4b), and thus a drying out of the nozzles 21, 22 of the one or more print heads 103 is at least delayed.

In an exemplary embodiment, a separating element 200 that, for example, is designed as a film is thus described that takes over the function of a purge basin of a cleaner 150. The separating element 200 may be drawn between a recording medium 120 and the print heads 103 for the cleaning of the print heads 103. The separating element 200 may thereby form a trough or channel into which ink and/or contaminants from the print heads 103 may be captured and from which ink and/or contaminants may drain. After the cleaning process of the print heads 103, the separating element 200 may be retracted again and possibly may be cleaned by a cleaner 204. During a printing process of the printing device 100, the separating element 200 may be borne such that the ink and/or contaminants that are captured by the separating element 200 may drain and/or drip off (for example in a capture container 203). The separating element 200, together with the one or more wipers 151, is preferably moved along the nozzle plates 160 of the print heads 103. To provide a parking function, the separating element 200 may be drawn completely below a print bar 102. Furthermore, the separating element 200 may be lowered onto the nozzle plates 160 of the print heads 102 so that the nozzles 21, 22 of the print heads 102 are sealed by the separating element 200. In particular, the separating element 200 may be pressed against the nozzle plates 160 of the print heads 102 in order to seal the nozzles 21, 22 of the print heads 102.

FIG. 5 shows a flowchart of a method 500 for regenerating at least one print head 103 of an inkjet printing device 100 according to an exemplary embodiment. The printing device 100 has a recording region 220, arranged below the print head 103, for a recording medium 120 to be printed to by the print head 103.

In an exemplary embodiment, the method 500 includes the movement 501 of a (flexible) planiform separating element 200 for a regeneration process in a gap or intervening space between the print head 103 and the recording region 220, so that fluid (in particular ink and/or contaminants) dripping from the print head 103 are captured by the separating element 200. The separating element 200 may thus be moved into the gap or intervening space between print head 103 and recording region 220 in order to shield or seal off the print head 103 from the recording region 220, and thus to protect a recording medium 120 that is arranged in the recording region 220 against fluids (for example ink, cleaning fluid, and/or contaminants) that arise in a regeneration process of the print head 103.

Moreover, the method 500 includes the implementation 502 of at least one regeneration measure for regeneration of the print head 103 if the separating element 200 is at least partially located in the gap or intervening space between the print head 103 and the recording region 220. Examples of regeneration measures are the purging of the print head 103 and/or the spraying of the nozzle plate 160 of the print head 103 with a cleaning fluid and/or the wiping of the print head 103 with a wiper 151 and/or with a cloth and/or with a cleaning belt. Via the use of a planiform separating element 200, these regeneration measures of the print head 103 may be implemented directly at the printing position, in particular directly above the recording region 220, and thus in a cost-, time-, and space-efficient manner. It may thereby be necessary, if applicable, to raise the print head 103 and/or to lower the recording region 220 in order to increase the width of the gap or of the intervening space so that the separating element 200 may be moved into said gap or intervening space.

A regenerator 210 for regenerating at least one print head 103 of an inkjet printing device 100 is thus described in this document. The printing device 100 typically includes at least one print bar 102 having at least one row of print heads 103. The print heads 103 may thereby be arranged along a direction (referred to as a cleaning direction 2 in this document) transversal to the transport direction 1 of a recording medium 120 to be printed to.

The printing device 100 has a recording region 220, arranged below the at least one print head 103 (in particular below the row of print heads 103 or below the print bar 102), for a recording medium 120 to be printed to by the print head 103.

The regenerator 210 includes a planiform separating element 200. The separating element 200 is thereby designed to be flexible or pliable. In particular, the separating element 200 may be designed as a film and/or a tarp. The separating element 200 may have a sufficiently large surface in order to completely shield or seal off the at least one print head 103 (in particular the entire print bar 102) entirely from the recording region 220. In particular. The separating element 200 may have such a large area that fluid (in particular ink, cleaning fluid, and/or contaminants) that drops down from the at least print head 103 (in particular from the print heads 103 of a print bar 102) is captured in its entirety by the separating element 200 (if the separating element 200 is located entirely in the gap or intervening space between the print head 103 or the print bar 102 and the recording region 220).

Moreover, the regenerator 210 includes an actuator (for example an electric motor) that, for a regeneration process, is configured to move the separating element 200 into the gap or intervening space between the print head 103 (or between the print bar 102) and the recording region 220 such that fluid dripping from the print head 103 is captured (in its entirety) by the separating element 200. Furthermore, the actuator may be configured to move the separating element 200 out of the gap between the print head 103 and the recording region 220 for a printing process. The separating element 200 thus enables the recording region 220 and the one or more print heads 103 to be shielded or sealed off from one another (entirely, meaning at every arbitrary point of the one or more print heads 103) as needed. The separating element 200 thus enables the regeneration of a print head 103 directly at the printing position (meaning directly above the recording region 220), where the print head 103 is typically raised in advance of a cleaning process in order to expand the intervening space between the print head 103 and the recording region 220.

In an exemplary embodiment, the regenerator 210 also includes a controller 101 that is configured to initiate at least one regeneration measure to regenerate the print head 103 if the separating element 200 is located at least partially in the intervening space between the print head 103 and the recording region 220. In particular, a purging of the print head 103 may be initiated. The ink pushed out of the print head 103 may thereby be (entirely) captured by the separating element 200. Moreover, a spraying of the nozzle plate 160 of the print head 103 with a cleaning fluid may be effected. Furthermore, a wiping of the nozzle plate 160 of the print head 103 may be initiated. The fluid (for example ink and/or cleaning fluid) that thereby drips and/or is wiped off may be (entirely) captured by the separating element 200. A cost-, time-, and space-efficient regeneration of a print head 103 is thus enabled. In an exemplary embodiment, processor circuitry of the controller 101 is configured to initiate at least one regeneration measure to regenerate the print head 103.

The separating element 200 may be designed to be flexible such that, due to the effect of gravity, the separating element 200 sags in the intervening space between the print head 103 (or the print bar 102) and the recording region 220 and forms a channel in which fluid dripping from the print head 103 is captured. The channel thereby travels along the gap or the intervening space, meaning along the cleaning direction 2 or orthogonal to the transport direction 1. The separating element 200 may thereby be attached to the edges (meaning the lateral edges) traveling along the cleaning direction 2 (for example to guide rails 205 for guiding the separating element 200 given the movement within the gap). Via the formation of a channel, fluid can be particularly reliably captured and collected and be transported away via the channel.

As has already been presented above, during a printing process the printing device 100 is configured to direct a recording medium 120 along the transport direction 1, past the at least one print head 103. The actuator may be configured to move the separating element 200 along the cleaning direction 2, transversal to the transport direction 1, into the intervening space between the print head 103 and the recording region 220 or out from the intervening space. A particularly space-efficient arrangement of the separating element 200 (in a side region of the printing device 100) is enabled via such an in-or-out lateral guidance of the separating element 200.

The part of the separating element 200 that is arranged in the gap or intervening space between the print head 103 and the recording region 220 may travel horizontally. The regenerator 210 may include a deflection unit, in particular a deflection roller 202, that is configured to deflect the separating element 200 such that said separating element 200 travels on an incline (meaning towards the floor on which the printing device 100 is standing) into a side region of the printing device 100 that is situated next to the recording region 220. The separating element 200 may thereby in particular travel at an angle of 45°, 60°, 80° or more, or essentially orthogonal to horizontal, in the side region. The installation space of the printing device 100 may thus be further reduced. Furthermore, a reliable discharge of ink and/or cleaning fluid and/or contaminants that have been captured by the separating element 200 may thus be produced. An efficient cleaning of the separating element 200 (in particular of the side of the separating element 200 that faces toward the print head 103) is thus enabled.

In an exemplary embodiment, the regenerator 210 includes a capture container 203 arranged between the separating element 200 (in particular between an edge or border of the separating element 200 that travels parallel to the transport direction 1) and the floor. The capture container 203 may be arranged such that fluid (for example ink and/or cleaning fluid and/or contaminants) captured by the separating element 200 flows and/or drips from said separating element 200 into said capture container 203.

In an exemplary embodiment, the regenerator 210 includes a cleaner 204 (for example with a wiper, with a blower, and/or with a stripper) that is configured to remove fluid captured by the separating element 200 from said separating element 200. The cleaner 204 is thereby preferably arranged such that the cleaning of the separating element 200 takes place while the separating element 200 is moved into or out of the gap between print head 103 and recording region 220. A reliable and efficient cleaning of the separating element 200 (for example after implementation of a regeneration measure) is thus produced.

In an exemplary embodiment, the regenerator 210 includes a sled 201, driven by the actuator, that is configured to guide the separating element 200 into or out of the intervening space between print head 103 and recording region 220. The sled 201 may thereby be guided along at least one guide rail 205. The at least one guide rail 205 thereby preferably travels along the cleaning direction 2.

In an exemplary embodiment, the regenerator 210 also includes a wiper 151 attached to the sled 201, and/or a cloth and/or a cleaning belt attached to the sled 201, that are respectively configured to wipe off the nozzle plate 160 of the print head 103 as a cleaning measure. The wiping may thereby preferably take place while the separating element 200 is being guided into or out of the intervening space. A particularly time- and space-efficient regeneration of a print head 103 is thus enabled.

An edge or border of the separating element 200 that travels along the intervening space or in the cleaning direction 2 may be attached, at least partially, to the guide rail 205 (for example similar to a curtain). In particular, the regenerator 210 may have two guide rails 205 that travel in front of or, respectively, behind the print head 103 (in particular the print bar 102) relative to the transport direction 1. The opposing edges or borders of the separating element 200 that travel along the intervening space or in the cleaning direction 2 may then be attached to a respective guide rail 205 so that the separating element 200 may be arranged as a kind of curtain below the print head 103 (or the print bar 102), between the two guide rails 205 (and thereby forms a channel along the cleaning direction 2). A particularly reliably shielding or walling off or sealing off between print head 103 and recording region 220 is thus produced.

In an exemplary embodiment, the regenerator 210 is configured to place the separating element 200 below the nozzle plate 160 of the print head 103 such that the separating element 200 covers or seals the nozzle plate 160 in order to delay a drying out of the nozzles 21, 22 of the print head 103. In particular, the separating element 200 may be stretched below the nozzle plate 160. For example, the print head 103 may be lowered so that the separating element 200 is pressed against the nozzle plate 160 and thereby covers or seals the nozzles 21, 22 of the print head 103. The necessary installation space of a printing device 100 may thus be further reduced (since the installation of separate coverings for the one or more print heads 103 of the printing device 100 may be foregone).

In an exemplary embodiment, the printing device 100 includes a row of print heads 103 that are arranged side by side, transversal to the transport direction 1 of the recording medium 120 (for example as part of a print bar 102). The actuator (in particular the sled 201) may be configured to move the separating element 200 into the gap or intervening space between the row of print heads 103 and the recording region 220 so that the individual print heads 103 of the row of print heads 103 are shielded or sealed off from the recording region 220 little by little by the separating element 200. A separating wall or a separating curtain (in the form of the separating element 200) may thus be drawn, little by little, in-between the print heads 103 and the recording region 220 (preferably along the cleaning direction 2).

In an exemplary embodiment, the controller 101 is configured to initiate at least one respective regeneration measure for the individual print heads 103, little by little, synchronously with the movement of the separating element 200 as soon as a print head 103 is shielded by the separating element 200 from the recording region 220. In other words, a regeneration measure for a print head 103 may be begun as soon as the print head 103 is shielded by the separating element 200. The time efficiency of the regeneration of a row of print heads 103 may thus be increased.

In an exemplary embodiment, the printing device 100 includes at least one print head 103 and at least one regenerator 210 described in this document for regeneration of the print head 103. In particular, the printing device 100 may include one or more print bars 102. A respective regenerator 210 described in this document for regeneration may be provided for each print bar 102. In addition to a separating element 200, the respective regenerator 210 for regeneration may also have means in order to purge, spray, and/or wipe the print bars 102.

The use of a separating element 200 that may be moved between a print bar 102 and a recording region 220 enables a fixed installation of the print bar 102 above the recording region 220, whereby the costs and the installation space of a printing device 100 may be reduced. Furthermore, the error rate in the cleaning of the nozzle plates 160 of the print heads 103 of a print bar 102 may be reduced, since the print bar 102 does not need to be moved into a separate cleaning position. Moreover, deposits on the surface of the separating element 200 may be avoided via the use of a flexible separating element 200 that may drain between cleaning processes.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processor circuitry” shall be understood to be circuit(s), processor(s), logic, or a combination thereof. A circuit includes an analog circuit, a digital circuit, state machine logic, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

1 transport direction (of the recording medium
2 cleaning direction (for example of a wiper in the cleaning of a print head)
21, 22 nozzle
31, 32 column (of the print image)
100 printing device
101 controller
102 print bar
103 print head
120 recording medium
150 cleaner
151 wiper
160 nozzle plate
200 separating element
201 sled
202 deflection roller
203 capture container
204 cleaner
205 guide rail
210 regeneration device
220 recording region (for the recording medium)
230 frame (of the printing device)
301 guide groove
302 sliding element
500 method for regenerating a print head
501-502 method steps

1. A regenerator for regenerating at least one print head of an inkjet printing device having a recording region arranged below the at least one print head for a recording medium to be printed to by the at least one print head, comprising:
a planiform separating element;
an actuator configured to:
in a regeneration process, move the separating element into an intervening space between the at least one print head and the recording region to capture fluid dripping from the at least one print head; and
in a printing process, move the separating element out of the intervening space between the at least one print head and the recording region; and
a controller configured to initiate a regeneration measure to regenerate the at least one print head if the separating element is located at least partially in the intervening space between the at least one print head and the recording region.

2. The regenerator according to claim 1, wherein the separating element is flexible such that the separating element is configured to sag between the at least one print head and the recording region due to gravity and form a channel in which fluid dripping from the at least one print head is captured.

3. The regenerator according to claim 2, wherein the separating element comprises a film and/or a tarp.

4. The regenerator according to claim 1, wherein the separating element comprises a film and/or a tarp.

5. The regenerator according to claim 1, wherein:
the printing device is configured to direct the recording medium along a transport direction, past the print head, during the printing process; and
the actuator is configured to move the separating element along a cleaning direction, transversal to the transport direction, into the intervening space between the at least one print head and the recording region.

6. The regenerator according to claim 5, wherein:
a part of the separating element that is arranged in the intervening space between the at least one print head and the recording region is arranged horizontally; and
the regenerator further comprises:
a deflector that is configured to deflect the separating element such that, in a side region situated laterally next to the recording region, the separating element travels downward toward a surface on which the printing device stands; and
a capture container arranged between the separating element and the floor in a side region, the capture container being arranged such that fluid captured by the separating element flows and/or drips from the separating element into the capture container.

7. The regenerator according to claim 6, wherein the deflector is a deflector roller.

8. The regenerator according to claim 6, wherein the separating element travels at an angle of at least 45° relative to a horizontal direction.

9. The regenerator according to any claim 1, wherein the regenerator further comprises a cleaner configured to remove fluid captured by the separating element from the separating element.

10. The regenerator according to any claim 9, wherein the cleaner is configured to remove the fluid captured by the separating element from the separating element while the separating element is being moved into the intervening space and/or out of the intervening space.

11. The regenerator according to claim 1, further comprising:
a sled driven by the actuator and configured to drive the separating element into the intervening space or out of the intervening space; and
a wiper configured to wipe off a nozzle plate of the at least one print head as a regeneration measure while the separating element is being moved into the intervening space and/or out of the intervening space.

12. The regenerator according to claim 11, further comprising:
at least one guide rail configured to guide the sled along the intervening space between the at least one print head and the recording region, wherein:
the guide rail travels along a cleaning direction that is transversal to a transport direction of the recording medium; and
an edge of the separating element that travels along the intervening space is at least partially attached to the guide rail.

13. The regenerator according to claim 1, wherein the regenerator is configured to place the separating element below a nozzle plate of the at least one print head such that the separating element seals the nozzle plate to delay a drying out of nozzles of the at least one print head.

14. The regenerator according to claim 1, wherein:
the printing device comprises a row of print heads arranged side by side, transversal to a transport direction of the recording medium;
the actuator is configured to move the separating element into the intervening space between the row of print heads and the recording region so that individual print heads of the row of print heads are progressively sealed off from the recording region by the separating element; and
the controller is configured to initiate at least one respective regeneration measure for the print heads synchronously with the movement of the separating element as soon as one of the individual print heads is sealed off from the recording region by the separating element.

15. A method for regenerating at least one print head of an inkjet printing device having a recording region arranged below the print head for a recording medium that is to be printed to by the at least one print head, comprising:
moving a flexible planiform separating element into an intervening space between the at least one print head and the recording region for a regeneration process so that fluid dripping from the print head is captured by the separating element; and
implementing at least one regeneration measure to regenerate the at least one print head if the separating element is located at least partially in the intervening space between the at least one print head and the recording region.

16. A non-transitory computer-readable storage medium with an executable program stored thereon, that when executed, instructs a processor to perform the method of claim 15.
